(19) United States
(12) Patent Application Publication
(10) Pub. No.: US 2023/0302951 A1
(43) Pub. Date: Sep. 28, 2023

(54) BATTERY REPLACEMENT STATION AND BATTERY TEMPERATURE MANAGEMENT METHOD

(71) Applicant: Isuzu Motors Limited, Yokohama-shi (JP)

(72) Inventor: Shinsaku YAMAGUCHI, Fujisawa-shi (JP)

(73) Assignee: Isuzu Motors Limited, Yokohama-shi (JP)

(21) Appl. No.: 18/124,647

(22) Filed: Mar. 22, 2023

(30) Foreign Application Priority Data
Mar. 25, 2022 (JP) 2022-049353

(51) Int. Cl. B60L 53/80; B60L 53/30; H02J 7/00; H01M 10/627

(52) U.S. Cl. CPC B60L 53/80; B60L 53/30; H02J 7/007194; H01M 10/627

(57) ABSTRACT

Provided is a battery replacement station in which a used battery that has been discharged is removed from a vehicle and is replaced with a charged battery. The battery replacement station includes: a battery storage area in which the charged battery is stored; and a temperature adjustment member storage area that stores a temperature adjustment member. The temperature adjustment member is detachably attachable to an outer surface of the charged battery and allows at least one of heat generation and/or heat absorption without including a heating medium flow path through which a heating medium circulates.

### CROSS REFERENCE TO RELATED APPLICATIONS

This application claims the benefit of priority of Japanese Patent Application No. 2022-049353, filed on Mar. 25, 2022, the contents of which are incorporated by reference as if fully set forth herein in their entirety.

### TECHNICAL FIELD

The present disclosure relates to a battery replacement station, in which a used battery is removed from an electric vehicle and is replaced with a charged battery, and a battery temperature management method at the battery replacement station.

### BACKGROUND ART

There is an idea of providing battery replacement stations in which a used battery that has been discharged is removed from an electric vehicle and is replaced with a charged battery. Further, Patent Literature (hereinafter referred to as “PTL”) 1 describes that a temperature-control loop that transfers heat by using a liquid medium is provided in a battery and a liquid temperature-control loop is caused to be independent of a temperature-control system of an automobile.

### CITATION LIST

Patent Literature

PTL 1

Japanese Utility Model (Registration) Application Laid-Open No. 3236379

### SUMMARY OF INVENTION

### Technical Problem

Since battery characteristics are affected by the surrounding temperature, the temperature of a battery at the time of attachment to a vehicle (electric vehicle) is preferably managed to be within a desired range. The temperature of a battery at the time of attachment to a vehicle can be managed by providing the battery with a liquid temperature-control loop independent of a temperature-control system of the vehicle as in PTL 1.

However, a battery provided with a heating medium flow path through which a heating medium circulates as in PTL 1 makes the battery heavier and/or makes the structure of the battery more complicated.

An object of the present disclosure is therefore to manage the temperature of a charged battery at the time of attachment to a vehicle without making the battery heavier and/or making the structure of the battery more complicated.

### Solution to Problem

In order to achieve the above-mentioned object, according to a first aspect of the present disclosure, there is provided a battery replacement station in which a used battery that has been discharged is removed from a vehicle and is replaced with a charged battery. The battery replacement station includes: a battery storage area in which the charged battery is stored; and a temperature adjustment member storage area that stores a temperature adjustment member. The temperature adjustment member is detachably attachable to an outer surface of the charged battery and allows at least one of heat generation and/or heat absorption without including a heating medium flow path through which a heating medium circulates.

According to a second aspect of the present disclosure, there is provided the battery replacement station according to the first aspect that further includes a battery replacement system. The battery replacement system includes: a battery replacement operation section that removes the used battery from the vehicle, which has stopped at a predetermined stop position, and attaches the charged battery to the vehicle; a battery transport section that transports the charged battery in the battery storage area to the battery replacement operation section; a temperature adjustment member transport section that transports the temperature adjustment member from the temperature adjustment member storage area; and a temperature adjustment member attachment operation section that attaches the temperature adjustment member, which has been transported by the temperature adjustment member transport section, to the outer surface of the charged battery before the charged battery is transported by the battery transport section or while the charged battery is being transported by the battery transport section.

According to a third aspect of the present disclosure, there is provided the battery replacement station according to the second aspect in which: the temperature adjustment member storage area is an area in which temperature management is performed, and the temperature adjustment member transport section starts transporting the temperature adjustment member outside from the temperature adjustment member storage area in accordance with an estimated time when the vehicle that requests replacement of the used battery arrives at the battery replacement station.

According to a fourth aspect of the present disclosure, there is provided a battery temperature management method at the battery replacement station according to the first aspect. The battery temperature management method includes: transporting the charged battery outside from the battery storage area; and transporting the temperature adjustment member outside from the temperature adjustment member storage area and attaching the temperature adjustment member to the outer surface of the charged battery. In the transporting of the temperature adjustment member and the attaching of the temperature adjustment member, the temperature adjustment member is attached to the outer surface of the charged battery before or immediately after the charged battery is transported outside from the battery storage area.

According to a fifth aspect of the present disclosure, there is provided the battery temperature management method according to the fourth aspect in which: the temperature adjustment member storage area is an area in which temperature management is performed, and in the transporting of the temperature adjustment member and the attaching of the temperature adjustment member, the transporting of the temperature adjustment member outside from the temperature adjustment member storage area is started in accordance with an estimated time when the vehicle that requests replacement of the used battery arrives at the battery replacement station.

### Advantageous Effects of Invention

According to the present disclosure, it is possible to manage the temperature of a charged battery at the time of attachment to a vehicle without making the battery heavier and/or making the structure of the battery more complicated.

### BRIEF DESCRIPTION OF DRAWINGS

FIGS. 1A and 1B are side views of a vehicle according to an embodiment of the present invention, FIG. 1A illustrates a state of the vehicle before battery replacement, and FIG. 1B illustrates a state of the vehicle during the battery replacement;

FIG. 2 schematically illustrates a configuration of a battery replacement station; and

FIG. 3 is a block diagram of a battery replacement system.

### DESCRIPTION OF EMBODIMENTS

Hereinafter, embodiments of the present disclosure will be described with reference to the accompanying drawings.

### Embodiment 1

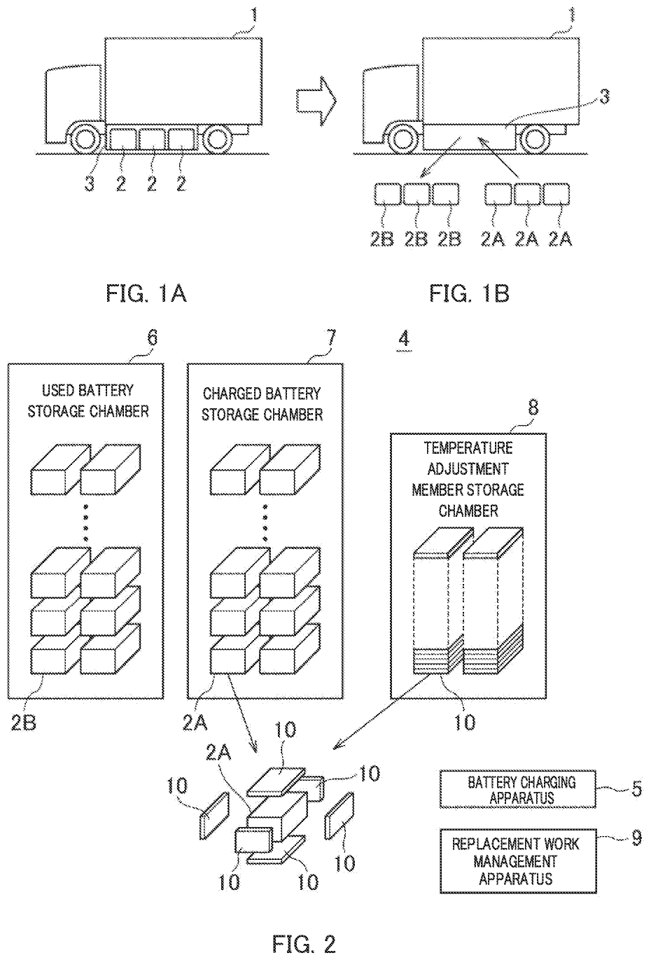

Vehicle 1 is, for example, an electric vehicle traveling by power supplied from battery 2 and includes, as illustrated in FIGS. 1A and 1B, battery attachment section 3 to which battery 2 is detachably attached. Used battery 2B that has been discharged by the traveling of vehicle 1 is removed from battery attachment section 3 and is replaced with charged battery 2A. Note that, although FIGS. 1A and 1B exemplify a truck as vehicle 1, vehicle 1 may be other than the truck (for example, a trailer, a passenger automobile, or the like). Further, charged battery 2A may be simply referred to as battery 2 in the description below.

Battery replacement station 4 is a facility in which used battery 2B is replaced with charged battery 2A and includes, as illustrated in FIG. 2, battery charging apparatus 5, used battery storage chamber 6, charged battery storage chamber (battery storage area) 7, temperature adjustment member storage chamber (temperature adjustment member storage area) 8, replacement work management apparatus 9, and the like.

As illustrated in FIGS. 1A, 1B, and 2, used batteries 2B that have been removed from vehicle 1 are stored in used battery storage chamber 6 and are sequentially charged by battery charging apparatus 5. Charged batteries 2A that have been charged by battery charging apparatus 5 are stored in charged battery storage chamber 7.

In temperature adjustment member storage chamber 8, temperature adjustment member 10 is stored. Temperature adjustment member 10 is a member that is detachably attachable to an outer surface of charged battery 2A and allows at least one of heat generation and/or heat absorption without including a heating medium flow path through which a heating medium circulates.

Since battery characteristics are affected by the surrounding temperature, the temperature of a battery at the time of attachment to vehicle 1 is preferably managed to be within a desired range (for example, 25° C. to 35° C.).

Temperature adjustment member 10 is attached to the outer surface of charged battery 2A for managing the temperature of a battery at the time of and immediately after attachment to vehicle 1 to be within the desired range. For example, battery 2 at the time of replacement is cooled by the heat absorption of temperature adjustment member 10 in a season or a region (for example, a tropical district) in which the air temperature is significantly higher than the upper limit temperature (35° C.) of the range described above, while battery 2 at the time of replacement is heated by the heat generation of temperature adjustment member 10 in a season or a region (for example, a cold district) in which the air temperature is significantly lower than the lower limit temperature (25° C.) of the range described above. As described above, since temperature adjustment member 10 including no heating medium flow path through which a heating medium circulates is used, the temperature of charged battery 2A at the time of attachment to vehicle 1 can be suitably managed without making battery 2 heavier and/or making the structure of battery 2 more complicated.

Temperature adjustment member 10 can be formed of, for example, a latent heat storage material, a semiconductor thermoelectric element, or the like. In a case where temperature adjustment member 10 is formed of a latent heat storage material, the temperature in temperature adjustment member storage chamber 8 is managed. For temperature adjustment member 10 in which the solidification temperature of the latent heat storage material is lower than the air temperature and battery 2 is cooled by heat absorption, the temperature in temperature adjustment member storage chamber 8 is managed to be lower than the solidification temperature (the inside of the chamber is cooled). For temperature adjustment member 10 in which the solidification temperature of the latent heat storage material is higher than the air temperature and battery 2 is heated by heat generation, on the other hand, the temperature in temperature adjustment member storage chamber 8 is managed to be higher than the solidification temperature (the inside of the chamber is heated).

The shape of temperature adjustment member 10 and the method of attaching temperature adjustment member 10 to battery 2 are not particularly limited, but use of temperature adjustment member 10 having a rectangular plate shape makes it possible to cover the six surfaces of battery 2 having a box shape with six temperature adjustment members 10 and to attach each temperature adjustment member 10 to battery 2 by bolts or the like.

Replacement work management apparatus 9 manages an estimated time when vehicle 1 that requests battery replacement arrives at battery replacement station 4 (estimated vehicle arrival time).

When vehicle 1 that requests replacement of battery 2 arrives at battery replacement station 4, a worker in battery replacement station 4 removes used battery 2B from vehicle 1 and attaches charged battery 2A to vehicle 1. In addition, the worker transports charged battery 2A outside from charged battery storage chamber 7 (transporting of the charged battery outside) before the attachment of charged battery 2A. Further, the worker transports temperature adjustment member 10 outside from temperature adjustment member storage chamber 8 and attaches temperature adjustment member 10 to the outer surface of charged battery 2A (transporting of the temperature adjustment member and attaching of the temperature adjustment member). In the transporting of the temperature adjustment member and the attaching of the temperature adjustment member, the worker attaches temperature adjustment member 10 to the outer surface of charged battery 2A before or immediately after charged battery 2A is transported outside from charged battery storage chamber 7.

Further, in a case where the temperature in temperature adjustment member storage chamber 8 is managed, the worker acquires an estimated vehicle arrival time from replacement work management apparatus 9 and starts transporting temperature adjustment member 10 outside from temperature adjustment member storage chamber 8 in accordance with the estimated time of arrival of vehicle 1. Specifically, temperature adjustment member 10 is transported outside from temperature adjustment member storage chamber 8 at a timing when the cooling effect or the heating effect on battery 2 by temperature adjustment member 10 can be effectively exerted at the time of the attachment of battery 2. Thus, temperature management by temperature adjustment member 10 can be efficiently performed.

### Embodiment 2

Battery replacement station 4 in Embodiment 2 includes battery replacement system in which battery replacement work is automated.

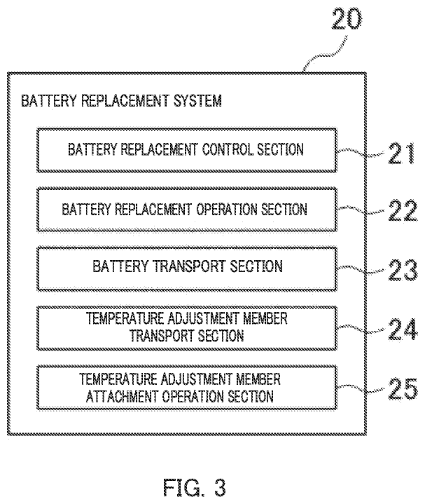

As illustrated in FIG. 3, battery replacement system 20 includes battery replacement control section 21, battery replacement operation section 22, battery transport section 23, temperature adjustment member transport section 24, and temperature adjustment member attachment operation section 25.

Battery replacement control section 21 is formed of, for example, an electronic control unit (ECU), and controls operations of battery replacement operation section 22, battery transport section 23, temperature adjustment member transport section 24, and temperature adjustment member attachment operation section 25. As illustrated in FIGS. 1A to 3, battery replacement operation section 22 removes used battery 2B from vehicle 1 that has stopped at a predetermined stop position set in advance for battery replacement station 4, and attaches charged battery 2A to vehicle 1. Battery transport section 23 transports used battery 2B from battery replacement operation section 22 to used battery storage chamber 6 and also transports charged battery 2A in charged battery storage chamber 7 to battery replacement operation section 22. Temperature adjustment member transport section 24 transports temperature adjustment member 10 to the outside from temperature adjustment member storage chamber 8. Temperature adjustment member attachment operation section 25 attaches temperature adjustment member 10, which has been transported by temperature adjustment member transport section 24, to the outer surface of charged battery 2A before charged battery 2A is transported by battery transport section 23 or while charged battery 2A is being transported by battery transport section 23.

In a case where the temperature in temperature adjustment member storage chamber 8 is managed, battery replacement control section 21 acquires an estimated vehicle arrival time from replacement work management apparatus 9. By the control of battery replacement control section 21, temperature adjustment member transport section 24 starts transporting temperature adjustment member 10 outside from temperature adjustment member storage chamber 8 at a timing in accordance with the estimated vehicle arrival time (a timing when the cooling effect or the heating effect on battery 2 by temperature adjustment member 10 can be effectively exerted at the time of the attachment of battery 2).

The present disclosure has been described thus far based on the embodiment described above. However, the present disclosure is not limited to the contents of the embodiment described above, but can be appropriately changed within the scope of the present invention as a matter of course. That is, it goes without saying that other embodiments, examples, operation technologies, and the like made by those skilled in the art or others based on this embodiment are all included in the scope of the present invention.

1. A battery replacement station in which a used battery is removed from a vehicle and is replaced with a charged battery, the used battery having been discharged, the battery replacement station comprising:
a battery storage area in which the charged battery is stored; and
a temperature adjustment member storage area that stores a temperature adjustment member, the temperature adjustment member being detachably attachable to an outer surface of the charged battery and allowing at least one of heat generation and/or heat absorption without including a heating medium flow path through which a heating medium circulates.

2. The battery replacement station according to claim 1, further comprising a battery replacement system, the battery replacement system including:
a battery replacement operation section that removes the used battery from the vehicle and attaches the charged battery to the vehicle, the vehicle having stopped at a predetermined stop position;
a battery transport section that transports the charged battery in the battery storage area to the battery replacement operation section;
a temperature adjustment member transport section that transports the temperature adjustment member from the temperature adjustment member storage area; and
a temperature adjustment member attachment operation section that attaches the temperature adjustment member to the outer surface of the charged battery before the charged battery is transported by the battery transport section or while the charged battery is being transported by the battery transport section, the temperature adjustment member having been transported by the temperature adjustment member transport section.

3. The battery replacement station according to claim 2, wherein:
the temperature adjustment member storage area is an area in which temperature management is performed, and
the temperature adjustment member transport section starts transporting the temperature adjustment member outside from the temperature adjustment member storage area in accordance with an estimated time when the vehicle arrives at the battery replacement station, the vehicle requesting replacement of the used battery.

4. A battery temperature management method at the battery replacement station according to claim 1, the battery temperature management method comprising:
transporting the charged battery outside from the battery storage area; and
transporting the temperature adjustment member outside from the temperature adjustment member storage area and attaching the temperature adjustment member to the outer surface of the charged battery, wherein
in the transporting of the temperature adjustment member and the attaching of the temperature adjustment member, the temperature adjustment member is attached to the outer surface of the charged battery before or immediately after the charged battery is transported outside from the battery storage area.

5. The battery temperature management method according to claim 4, wherein:
the temperature adjustment member storage area is an area in which temperature management is performed, and
in the transporting of the temperature adjustment member and the attaching of the temperature adjustment member, the transporting of the temperature adjustment member outside from the temperature adjustment member storage area is started in accordance with an estimated time when the vehicle arrives at the battery replacement station, the vehicle requesting replacement of the used battery.
